(19) United States
(12) Patent Application Publication
(10) Pub. No.: US 2012/0250660 A1
(43) Pub. Date: Oct. 4, 2012

(54) MAXIMUM ALLOWED QUALITY OF SERVICE PROCEDURES USING GN/GP

(75) Inventor: Josefin KARLSSON, TORSLANDA (SE)

(73) Assignee: TELEFONAKTIEBOLAGET L M ERICSSON (PUBL), Stockholm (SE)

(21) Appl. No.: 13/438,862

(22) Filed: Apr. 4, 2012

Related U.S. Application Data
(60) Provisional application No. 61/471,424, filed on Apr. 4, 2011.

(51) Int. Cl. H04W 36/30; H04W 24/00

(52) U.S. Cl. 370/332; 370/328

(57) ABSTRACT

The example embodiments presented herein are directed towards a core network node (400), and corresponding method therein, for radio resource management with the use of a maximum allowed Gn/Gp SGSN Quality of Service (QoS) parameter reflecting a maximum allowed QoS of a serving network. The core network node (400) comprises the maximum allowed Gn/Gp SGSN QoS parameter with a QoS parameter associated with a communications request. Based on the comparison, the core network node (400) may provide a decision on the communications request based on the comparison. The decision may be a rejection or an allowance of a procedure defined in the communications request. Furthermore, the core network node (400) may restrict a requested QoS associated with the communications request.

### RELATED APPLICATIONS

This application claims the benefit of U.S. Provisional Application No. 61/471,424, filed on Apr. 4, 2011. The entire teachings of the above application are incorporated herein by reference.

### BACKGROUND

In a typical cellular system, also referred to as a wireless communications network, wireless terminals, also known as mobile stations and/or user equipment units communicate via a Radio Access Network (RAN) to one or more core networks. The wireless terminals can be mobile stations or user equipment units such as mobile telephones also known as “cellular” telephones, and laptops with wireless capability, e.g., mobile termination, and thus can be, for example, portable, pocket, hand-held, computer-comprised, or car-mounted mobile devices which communicate voice and/or data with radio access network.

The radio access network covers a geographical area which is divided into cell areas, with each cell area being served by a base station, e.g., a Radio Base Station (RBS), which in some networks is also called “NodeB” or “B node” and which in this document also is referred to as a base station. A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units within range of the base stations.

In some versions of the radio access network, several base stations are typically connected, e.g., by landlines or microwave, to a Radio Network Controller (RNC). The radio network controller, also sometimes termed a Base Station Controller (BSC), supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipment units (UEs). The Third Generation Partnership Project (3GPP) has undertaken to evolve further the UTRAN and GSM based radio access network technologies. Long Term Evaluation (LTE) together with Evolved Packet Core (EPC) is the newest addition to the 3GPP family.

Mobility management is an important function in maintaining cellular networks. The goal of mobility management is to track where cellular phones, or user equipments, are located in order for mobile phone services to be provided to the various user equipments comprised in any given network. The network nodes which are primarily responsible for mobility management are the Mobility Management Entity (MME) and the Serving General Packet Radio Service Support Node (SGSN).

### SUMMARY

At least one object of the example embodiments presented herein is to provide enhanced management of radio resources, during mobility, activation or modification procedures, in an efficient manner. Currently, there are no means for providing a Quality of Service (QoS) capability of a serving network in Gn/Gp SGSN procedures. Thus, some of the example embodiments presented herein may be directed towards a core network node (e.g., a Gn/Gp SGSN or GGSN) analyzing a maximum allowed SGSN QoS with respect to a QoS associated with a requesting procedure. Based on this analysis the core network node may provide a decision (e.g., to allow, reject, or restrict a requested QoS) on the requesting procedure. The Gn/Gp may also forward the maximum allowed SGSN QoS to other nodes in the network. The maximum allowed SGSN may reflect the QoS capabilities of the serving network. Thus, other nodes in the network (e.g., the PGW, GGSN and/or PCRF) may provide QoS related decision with the knowledge of serving network capabilities.

Therefore, some of the example embodiments may be directed towards a core network node for radio resource management. The core network node is comprised in a radio network. The core network node comprises receiving circuitry configured to receive, from a requesting node, a communications request, where the communications request is a PDP context activation or a PDP context modification request. The core network node further comprises processing circuitry configured to process a QoS parameter with a maximum allowed Gn/Gp SGSN QoS parameter. The maximum allowed Gn/Gp SGSN QoS parameter indicates a maximum allowed QoS of a serving network, and the QoS parameter is associated with the communications request. The processing circuitry is further configured to determine a communication decision, within the core network node, for the communications request based on the comparison.

Some of the example embodiments may also be directed towards a method in a core network node for radio resource management. The core network node is comprised in a radio network. The method comprises receiving, from a requesting node, a communications request, wherein the communications request is a PDP context activation or a PDP context modification request. The method also comprises comparing a QoS parameter with a maximum allowed Gn/Gp SGSN QoS parameter. The maximum allowed Gn/Gp SGSN QoS parameter indicates a maximum allowed QoS of a serving network. The QoS parameter is associated with the communications request. The method further comprises determining a communication decision, within the core network node, for the communications request based on the comparing.

### DEFINITIONS

### AMBR Aggregate Maximum Bit Rate

### APN Access Point Name

### BSC Base Station Controller

GBR Guaranteed bit rate

### GGSN Gateway GPRS Support Node

### GPRS General Packet Radio System

### MBR Maximum Bit Rate

### QoS Quality of Service

### PCRF Policy and Charging Rules Function

### P-GW PDN Gateway

### PDP Packet Data Protocol, e.g IP

### RAN Radio Access Network

### RNC Radio Network Controller

### SGSN Serving GPRS Support Node

### S-GW Serving Gateway

### UE User Equipment

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1-3 are examples of radio or wireless communications networks that may utilize the example embodiments presented herein;

FIG. 4 is a message sequence diagram depicting a Routing Area Update, according to some of the example embodiments;

FIG. 5 is a message sequence diagram depicting a handover procedure, according to some of the example embodiments;

FIG. 6 is an example core network node configuration, according to some of the example embodiments; and

FIG. 7 is a flow diagram depicting example operations of the core network of FIG. 6, according to some of the example embodiments.

### DETAILED DESCRIPTION

In the following description, for purposes of explanation and not limitation, specific details are set forth, such as particular components, elements, techniques, etc. in order to provide a thorough understanding of the example embodiments. However, it will be apparent to one skilled in the art that the example embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

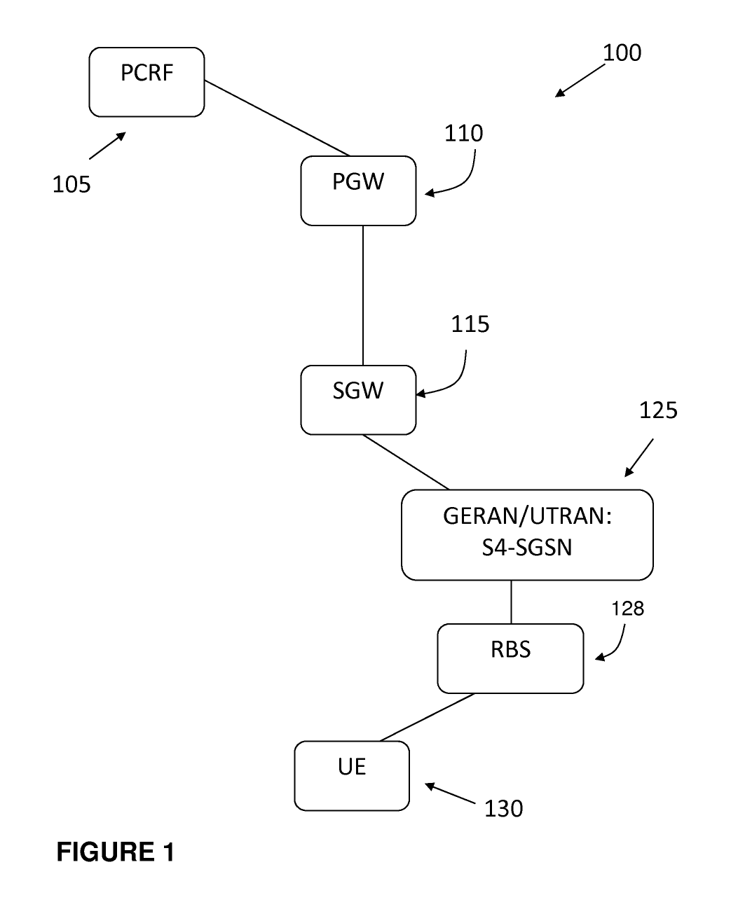

FIG. 1 shows a schematic view of a first system 100 in which some of the example embodiments may be applied. The system 100 is a so called 2G/3G system, also sometimes referred to as a GERAN/UTRAN system. As shown, the system 100 can accommodate a number of user equipments one of which is shown as an example, with the reference number 130. Naturally, the system 100 can accommodate a large number of user equipments and is not limited to accommodating only one user equipment.

All traffic to and from the user equipment 130 is routed via a so called “base station”, which, depending on the nature of the system, has different names. In the case of a GERAN/UTRAN system such as the one in FIG. 1, the base station is in this text referred to by the generic name “Radio Base Station”, here and in FIG. 1 abbreviated as RBS. The RBS which the user equipment 130 is connected to is shown in FIG. 1 as RBS 128. One example of a system specific name for an RBS is NodeB, as used in 3G systems, and another example is BTS, Base Transceiver System, as used in some 2G systems.

Regardless of the kind of system, the mobility of the user equipment 130 is controlled by what will here initially be referred to generically as a “mobility management node”, which, as shown in FIG. 1, in the case of GERAN/UTRAN is a so called S4-SGSN, shown as 125 in FIG. 1.

The “mobility management node” is connected to a Serving Gateway, an SGW 115, which in turn is connected to a PDN Gateway, PGW 110. The PGW 110 can be connected to a unit or a function for Policy and Charging Rules Function, a so called PCRF 105, or the PGW 110 can be arranged to take certain policy and charging actions on its own without the use of a PCRF.

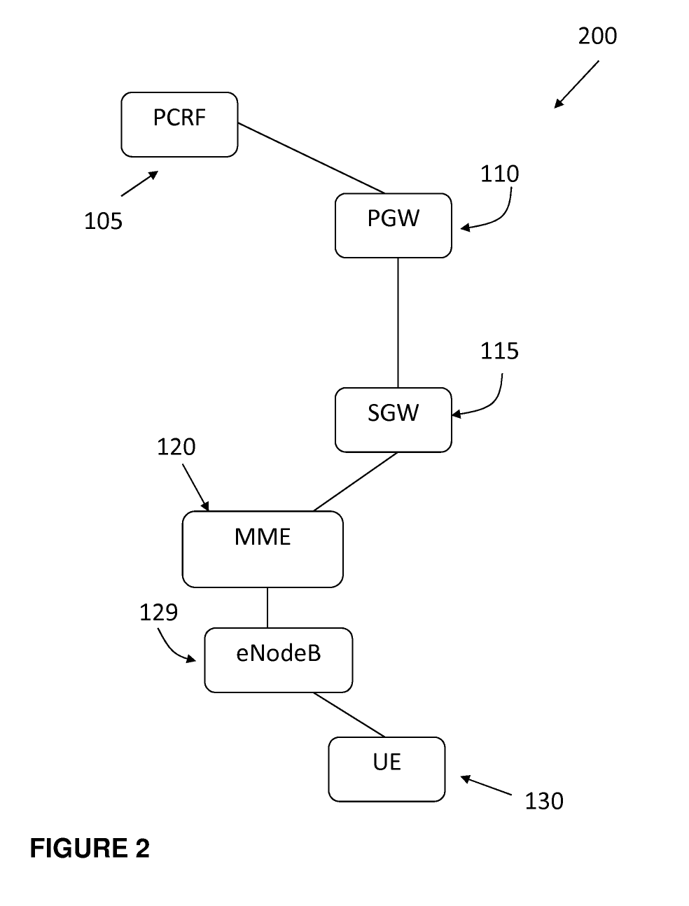

FIG. 2 shows a schematic overview of a second system 200 in which some of the example embodiments may be applied. The system 200 is a so called LTE based system, also referred to as an EUTRAN system. It should be pointed out that the terms “LTE” and “LTE based” system is here used to include both present and future LTE based systems, such as, for example, advanced LTE systems.

In a EUTRAN system such as the one 200 in FIG. 2, the “base station” is referred to as an eNodeB, shown as 129 in FIG. 2. The “mobility management node” is in a EUTRAN system referred to as a Mobility Management Entity (MME) shown as 120 on FIG. 2. The SGW and PGW of the system in FIG. 2 are similar to those in FIG. 1, and will for that reason not be described again here, which is also the case for the PCRF 105.

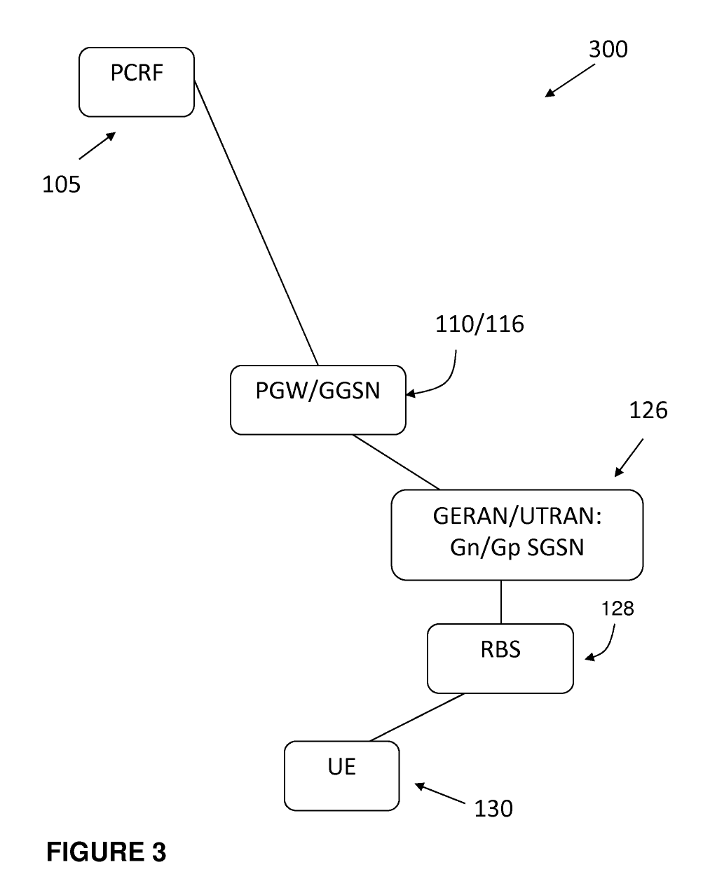

FIG. 3 illustrates an example of a third system 300 in which the example embodiments may be applied. The system 300 is another example of a GERAN/UTRAN where the mobility management node is a Gn/Gp SGSN 126. The Gn/Gp SGSN 126 may be connected to Gateway General Packet Radio Service Support Node (GGSN) 116 which may in turn be connected to the PGW 110 or the GGSN 116. The PGW 110 or the GGSN 116 may be in connection with the PCRF 105.

It should be appreciated that although FIGS. 1 and 3 show a systems 100 and 300 which are GERAN/UTRAN systems and FIG. 2 shows a system 200 which is an EUTRAN system, the example embodiments may also be applied in systems which combine these two technologies, i.e. combined GERAN/UTRAN and EUTRAN systems. Furthermore, the example embodiments may be applied to procedures which involve communications within and between the various systems.

Example embodiments are presented herein to provide enhanced management of radio resources, during mobility or modification procedures, in an efficient manner. As a part of the solution according to the example embodiments discussed herein, problems with current solutions will be identified and discussed.

In wireless access systems such as, for example, the systems described in FIGS. 1-3, problems may arise for user equipments in certain situations. Such situations may be, for example, roaming, modification, or mobility procedures. An example of a roaming or mobility procedure may be, for example, when a user equipment enters a network which belongs to a different operator, e.g., a change of the so called Public Land Mobile Network (PLMN). These problems may lead to the termination of the user equipment's connection to the system or to the user equipment receiving a lower level of Quality of Service, QoS, than possible.

The problems discussed above are due to limited functionality in the core network. The maximum QoS for an user equipment is limited by at least the capability or policies of the user equipment's serving network as subscription policies associated with the user equipment.

In 3GPP SA2—Architecture (Serving and Systems aspects) #83, it was presented to include the Max MBR (Maximum Bit Rate) and APN-AMBR (Access Point Name—Aggregate Maximum Bit Rate) for several procedures described in 3GPP 23.060 for Gn/Gp-SGSN and S4-SGSN. This means the Max APN-AMBR may be sent from a S4-SGSN to a PGW and PCRF (if a PCRF is deployed) when a procedure is triggered. For Gn/Gp-SGSN this means the Max MBR or Max APN-AMBR is sent to the GGSN and PCRF (if a PCRF is deployed) when a procedure is triggered.

The GGSN and PGW assure that the authorized MBR or APN-AMBR is selected not to exceed the Max MBR/AMBR if a PCRF is not deployed. But if a PCRF is deployed, the PCRF assures the authorized MBR or APN-AMBR is selected not to exceed Max MBR/APN-AMBR. The procedures triggering this sending of the Max MBR/APN-AMBR are mobility management and session management procedures in described 3GPP 23.060.

The reason for introducing Max MBR/APN-AMBR in 3GPP was to solve the pre-release 7 user equipment from not being able to support bit rates above 16 Mbps. This 16 Mbps user equipment limitation needs to be sent to the GGSN, PDN-GW and PCRF to make sure no upgrade of the bit rate is exceeded in any procedure.

For Gn/Gp procedures, this should not be limited to the QoS parameters MBR and APN-MBR for non-GBR PDP Context. There are other QoS parameters and also PDP Contexts with GBR that is not covered. There are further other 23.060 procedures where Max AMBR/APN-AMBR needs to be introduced.

Thus, in general, example embodiments presented herein may be utilized to allow the Gn/Gp SGSN to send Max Allowed QoS capabilities to the GGSN, and vice versa, in procedures to let the GGSN/PCRF or PGW/PCRF, or the Gn/Gp SGSN, make a policy decision in line with what the serving network can accept. The authorized values from GGSN/PCRF or PGW/PCRF are comprised in the response message to the Gn/Gp-SGSN. By this, the Gn/Gp-SGSN has a means to know how to handle the continuation of the procedure, for example, to continue the procedure, to reject the procedure, or to restrict the procedure. Also PGW/PCRF and GGSN/PCRF have the knowledge to make a better policy decision based on the received maximum allowed QoS.

The example embodiments presented herein may also be used in extending the maximum allowed QoS with a wider definition when Gn/Gp-SGSN procedures are performed. Furthermore, it should be appreciated that Rel-99 QoS and Rel-97 QoS parameters defined in 23.107 may also be comprised in the maximum allowed QoS. According to some of the example embodiments, maximum allowed QoS may also be sent by the Gn/Gp-SGSN to reflect roaming agreements for the subscriber and the serving network capability changed due to a PLMN change.

Below general examples of Gn/Gp procedures which may utilize the example embodiments will be presented. Thereafter, an example core network node configuration and example core network node operations will be provided. An example of a Gn/Gp procedure which may utilize the example embodiments presented herein is a PDP Context Activation. According to some of the example embodiments, the max allowed QoS or QoS parameter of the Gn/Gp SGSN may be comprised in Create PDP Context Request from the Gn/Gp-SGSN to the GGSN and/or in IP-CAN Session Establishment from the GGSN to the PCRF as described in 3GPP 23.060 in chapter 9.2.2.1. According to some of the example embodiments, the maximum allowed Gn/Gp SGSN QoS parameter, a new parameter, may comprise other parameters than the APN-AMBR and MBR in Bearer Level QoS parameters and Release 99 QoS parameters.

Another example Gn/Gp procedure which may utilize the example embodiments is a Secondary PDP Context Activation. During the procedure, the maximum allowed Gn/Gp SGSN QoS parameter may be comprised in a Create PDP Context Request from the Gn/Gp SGSN to the GGSN and the GGSN to the PCRF, as described in 3GPP 23.060 chapter 9.2.2.1.1. According to some of the example embodiments, the maximum allowed Gn/Gp SGSN QoS parameter, a new parameter, may comprise Bearer Level QoS parameters and Release 99 QoS parameters. The procedure is not currently defined in 3GPP with the parameter max MBR/APN-AMBR.

Another example Gn/Gp procedure which may utilize the example embodiments is a network requested PDP context activation, which comprises the same handling as for the PDP context activation named above, and described in 3GPP 23.060 chapter 9.2.2.2. According to some of the example embodiments, the maximum allowed Gn/Gp SGSN QoS parameter, a new parameter, may comprise other parameters than the APN-AMBR and MBR in Bearer Level QoS parameters and Release 99 QoS parameters.

Another example of a Gn/Gp procedure which may utilize some of the example embodiments is a network initiated Secondary PDP Context Activation, which may comprise the same handling as for the secondary PDP context activation described above and in 3GPP 23.060 chapter 9.2.2.3. According to some of the example embodiments, the maximum allowed Gn/Gp SGSN QoS parameter, a new parameter, may comprise Bearer Level QoS parameters and Release 99 QoS parameters. The procedure is not currently defined in 3GPP with the parameter max MBR/APN-AMBR.

Another example of a Gn/Gp procedure that may utilize some of the example embodiments is a SGSN initiated modification procedure, where the maximum allowed Gn/Gp SGSN QoS parameter may be comprised in an Update PDP Context Request from the Gn/Gp-SGSN to the GGSN and/or in IP-CAN Session Modification from the GGSN to the PCRF, as described in 3GPP 23.060 in chapter 9.2.3.1. According to some of the example embodiments, the maximum allowed Gn/Gp SGSN QoS parameter, a new parameter, may comprise Bearer Level QoS parameters and Release 99 QoS parameters. The procedure is not currently defined in 3GPP with the parameter maximum MBR/APN-AMBR.

Another example of a Gn/Gp procedure which may utilize some of the example embodiments presented herein is a GGSN initiated modification, where the maximum allowed Gn/Gp SGSN QoS parameter may be comprised in an Update PDP Context Response from the Gn/Gp-SGSN to the GGSN and/or in IP-CAN Session Modification from the GGSN to the PCRF, in case the PCRF has triggered this procedure, as is described in 3GPP 23.060 in chapters 9.2.3.1 and 9.2.3.2). According to some of the example embodiments, the maximum allowed Gn/Gp SGSN QoS parameter, a new parameter, may be comprised in a Bearer Level QoS parameters and Release 99 QoS parameters. If the QoS Requested comprises a QoS parameter which has the value above the maximum allowed Gn/Gp SGSN QoS parameter, the Gn/Gp-SGSN may reject or restrict the procedure and optionally the Gn/Gp SGSN can provide the maximum allowed Gn/Gp SGSN QoS parameter in an Update PDP Context Response. The procedure is not currently defined in 3GPP with the parameter max MBR/APN-AMBR.

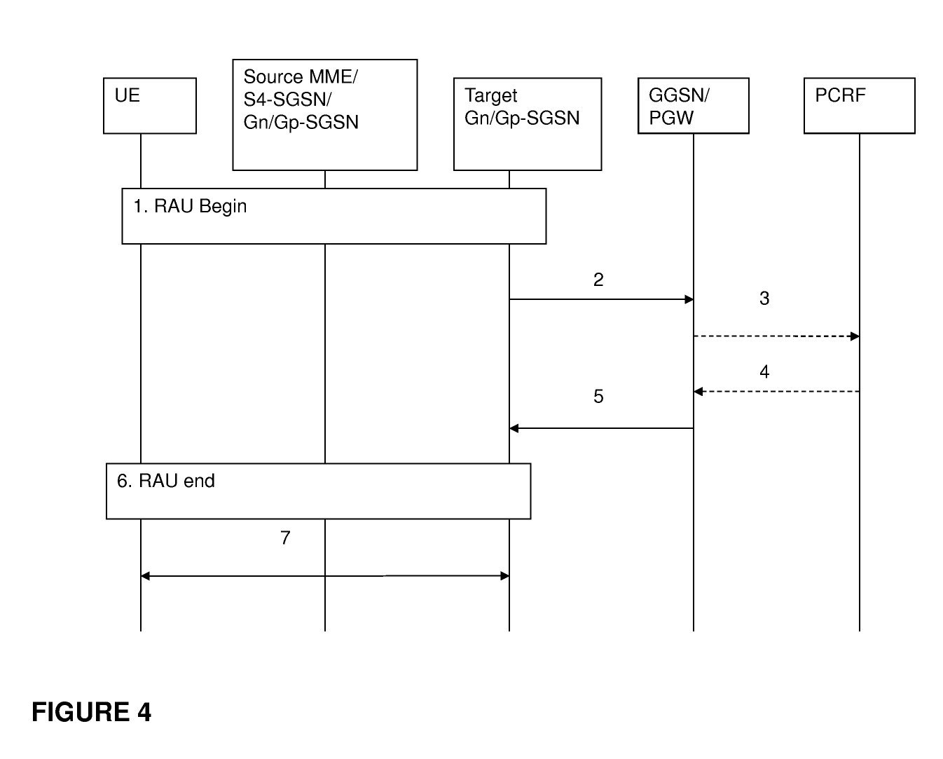

Another example of a Gn/Gp procedure which may utilize some of the example embodiments presented herein is an Inter SGSN Routing Area Update for an A/Gb mode, as is described in 3GPP in 23.060 in chapter 6.9.1.2.2. According to some of the example embodiments, the Max Allowed QoS associated with the Gn/Gp SGSN, a new parameter, may comprise Bearer Level QoS parameters and Release 99 QoS parameters. This information is may be provided in an Update PDP Context Request, sent from the Gn/Gp SGSN to the GGSN and further to the PCRF, if deployed. This procedure is not currently defined in 3GPP with the parameter max MBR/APN-AMBR. This procedure will be described in greater detail in relation to FIG. 4.

Another example of a Gn/Gp procedure which may utilize some of the example embodiments presented herein is a Combined SGSN RA/LA Update for an A/Gb mode as described in 3GPP in 23.060 in chapter 6.9.1.3.2. According to some of the example embodiments, the maximum allowed Gn/Gp SGSN QoS parameter, a new parameter, may comprise Bearer Level QoS parameters and Release 99 QoS parameters. This information is may be provided in an Update PDP Context Request, sent from the Gn/Gp SGSN to the GGSN and further to the PCRF, if deployed. This procedure is not currently defined in 3GPP with the parameter max MBR/APN-AMBR. This procedure will be described in greater detail in relation to FIG. 4.

Another example of a Gn/Gp procedure which may utilize some of the example embodiments presented herein is a Routing Area Update procedure for an lu mode as described in 3GPP 23.060 in chapter 6.9.2.1. According to some of the example embodiments, the maximum allowed Gn/Gp SGSN QoS parameter, a new parameter, may comprise Bearer Level QoS parameters and Release 99 QoS parameters. This information is may be provided in an Update PDP Context Request, sent from the Gn/Gp SGSN to the GGSN and further to the PCRF, if deployed. This procedure is not currently defined in 3GPP with the parameter max MBR/APN-AMBR. This procedure will be described in greater detail in relation to FIG. 4.

A further example of a Gn/Gp procedure which may utilize some of the example embodiments presented herein is an Intra SGSN Routing Area Update for an A/Gb mode and an lu mode, which is described in 3GPP 23.060 in chapter 6.9.1.2.1. This procedure will be described in greater detail in relation to FIG. 4.

Another example of a Gn/Gp procedure which may utilize some of the example embodiments presented herein is a Combined Intra SGSN RA/LA Update for an A/Gb mode as described in 3GPP 23.060 in chapter 6.9.1.3.1. This procedure will be described in greater detail in relation to FIG. 4.

Another example of a Gn/Gp procedure which may utilize some of the example embodiments presented herein is a Serving RNS Relocation procedure, as described in 3GPP 23.060 in chapter 6.9.2.2. This procedure will be described in greater detail in relation to FIG. 4.

Another example Gn/Gp procedure which may utilize some of the example embodiments presented herein is a Combined hard handover and SRNS Relocation procedures as described in 3GPP 23.060 in chapter 6.9.2.2.2. This procedure will be described in greater detail in relation to FIG. 4.

Another example Gn/Gp procedure that may utilize some of the example embodiments presented herein is a Combined Cell/URA Update and SRNS Relocation procedure as described in 3GPP 23.060 in chapter 6.9.2.2.3. This procedure will be described in greater detail in relation to FIG. 4.

Another example of a Gn/Gp procedure that may utilize some of the example embodiments presented herein is an Enhanced Serving RNS relocation Procedure, as described in 3GPP 23.060 in chapter 6.9.2.2.5. This procedure will be described in greater detail in relation to FIG. 4.

It should further be appreciated that the example embodiments described herein may also be applied to MS initiated modifications, as described in 3GPP 23.060 in chapter 9.2.3.3. The example embodiments described herein may further be applied to idle mode procedure, for example, the procedures described in 3GPP 23.401.

It should further be appreciated that the example embodiments described herein may also be applied to RAU, as described in 3GPP 23.401 in annex D.3.5.

It should further be appreciated that the example embodiments described herein may also be applied to Gn/Gp SGSN to MME TAU, as described in 3GPP 23.401 in annex D.3.5.

It should further be appreciated that the example embodiments described herein may also be applied to MME to 3G-SGSN combined hard handover and SRNS relocation procedure, as described in 3GPP 23.401 in annex D.3.3.

It should further be appreciated that the example embodiments described herein may also be applied to 3G-SGSN to MME combined hard handover and SRNS relocation procedure, as described in 3GPP 23.401 in annex D.3.4.

FIG. 4 illustrates a message sequence diagram for a Routing Area Update utilizing some of the example embodiments presented herein. The flow illustrated in FIG. 4 is applicable for the following RAU procedures:

Inter SGSN Routing Area Update for A/Gb mode

Combined SGSN RA/LA Update for A/Gb mode

Routing Area Update procedure for lu mode

Intra SGSN Routing Area Update for A/Gb mode and lu mode

RAU

It should be appreciated that, according to some of the example embodiments, this procedure may feature new signalling to and from the Gn/Gp-SGSN and the GGSN (e.g., an Update PDP context Request/Response) and the PCRF may needed to reflect a change of the serving network capability, for instance due to a PLMN change, by sending the maximum allowed Gn/Gp SGSN QoS parameter in Update PDP context Request. It should be appreciated that messages of FIG. 4 may also be performed.

Combined Intra SGSN RA/LA Update for A/Gb mode

It should be appreciated that, according to some of the example embodiments, this procedure may feature new signalling from the Gn/Gp-SGSN to the GGSN (e.g., Update PDP context Request/Response) and the PCRF may needed to reflect a change of the serving network capability, for instance due to a PLMN change, by sending the maximum allowed Gn/Gp SGSN QoS parameter in Update PDP context Request. It should be appreciated that messages of FIG. 4 may also be performed.

Message 1: A RAU request is sent by the user equipment to the target Gn/Gp-SGSN. This will trigger an exchange of context data from source MME/S4-SGSN/Gn-Gp-SGSN to the target Gn/Gp-SGSN.

Message 2: The target MME/S4-SGSN/Gn/Gp SGSN will send a Update PDP Context Request message to the GGSN. According to some of the example embodiments, the maximum allowed Gn/Gp SGSN QoS parameter may be provided in the message.

Message 3: In the case of a dynamic PCRF is being deployed, an update may be initiated over Gx. According to some of the example embodiments, the maximum allowed Gn/Gp SGSN QoS parameter may be sent from the GGSN to the PCRF over Gx. In the case of roaming, the parameter may in addition be provided over S9 from the V-PCRF to the H-PCRF. The GGSN is not required to await the PCRF answer but may proceed directly with message 5 before message 4 is received.

Message 4: In the case a dynamic PCRF is being deployed, the (H-)PCRF responds with a policy decision. According to some of the example embodiments, in case the PCRF supports the proposed feature it should not decide on a QoS higher than the provided maximum allowed QoS for the default bearer or for any potential following dedicated bearers. Furthermore, according to some of the example embodiments, if this message was received after the GGSN has responded with a Update PDP Context Response to the Gn/Gp SGSN and the policy decision from the PCRF is not in line with maximum allowed QoS that was accepted for the existing PDP context of the PDN connection, then the GGSN shall attempt to update the affected bearers with the applicable QoS.

Message 5: In the case a dynamic PCRF was not deployed in the network, message 3 and 4 do not apply. In this case, it is the GGSN that makes a local policy decision (based e.g. on configuration). According to some of the example embodiments, for this case if the GGSN supports the proposed feature, or the maximum allowed QoS associated with the SGSN, it should not decide on a QoS higher than the provided maximum allowed QoS for the default bearer or for any potential dedicated bearers. The GGSN responds with an Update PDP Context Response.

According to some of the example embodiments, in the case where the GGSN supports maximum allowed Gn/Gp SGSN QoS parameter and in case the maximum allowed QoS is lower than the current QoS of the PDN connections or any of the related PDP contexts, the GGSN may indicate that it accepts the Gn/Gp-SGSN provided maximum allowed QoS in the Update PDP Context Response. The GGSN may indicate the selected QoS.

Message 6: The RAU procedure is finalized according to standard procedures described in 3GPP.

Message 7: According to some of the example embodiments, after the RAU Accept has been sent to the user equipment, in case the maximum allowed Gn/Gp SGSN QoS parameter is lower or equal than the current QoS of the PDN connections or any of the related PDP contexts, and the GGSN has indicated that it accepts the Gn/Gp SGSN provided maximum allowed QoS in the Update PDP Context Response, then the Gn/Gp-SGSN may initiate a SGSN initiated Modify PDP Context procedure towards the user equipment but without the signalling towards the GGSN. When the Gn/Gp SGSN receives the Modify PDP Context Accept from the user equipment, there should be no signalling towards the GGSN. Also modifications from the Gn/Gp-SGSN towards the RNC/BSC may be initiated for this reason and without signalling towards the GGSN.

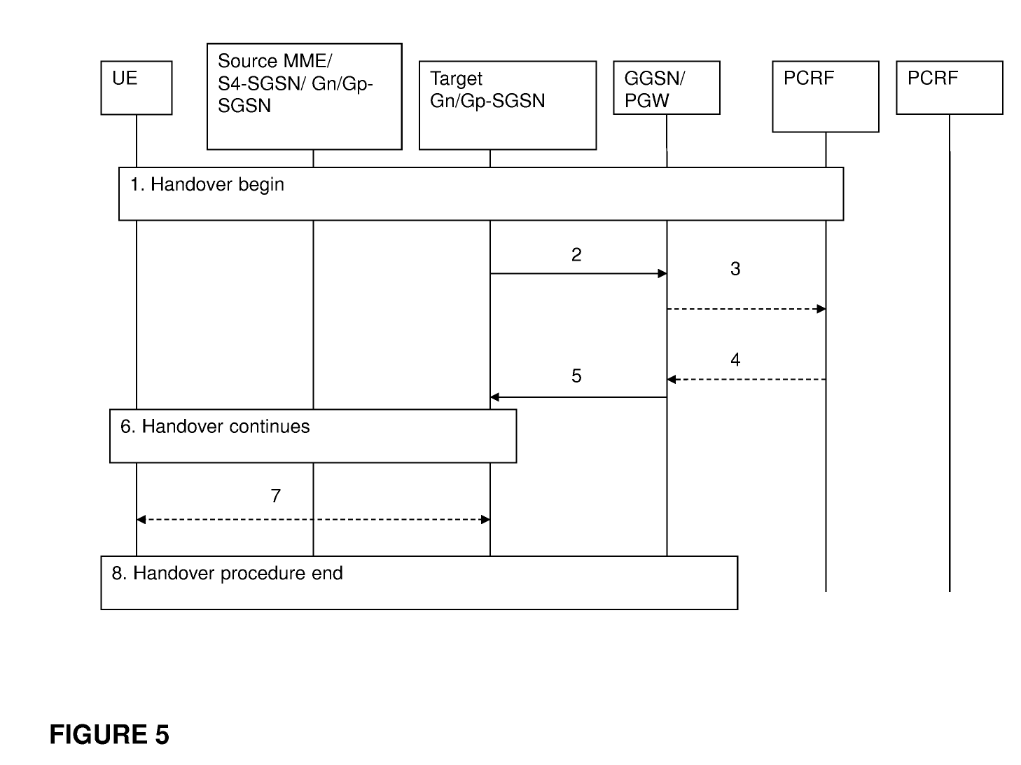

FIG. 5 illustrates a message sequence diagram for a Handover procedure utilizing some of the example embodiments presented herein. The flow illustrated in

FIG. 5 is applicable to the following procedure:

Serving RNS Relocation procedures

Combined hard handover and SRNS Relocation procedures

Combined Cell/URA Update and SRNS Relocation procedure

Enhanced Serving RNS relocation procedures

MME to 3G-SGSN combined hard handover and SRNS relocation procedure

3G-SGSN to MME combined hard handover and SRNS relocation procedure

Message 1: The handover procedure begins, including the preparation phase and the beginning of the execution phase to the target Gn/Gp SGSN. This will trigger an exchange of context data from source MME/S4-SGSN/Gn/Gp-SGSN to the target Gn/Gp-SGSN.

Message 2: The target Gn/Gp SGSN will send an Update PDP Context Request message to the GGSN or PGW. According to some of the example embodiments, the maximum allowed Gn/Gp SGSN QoS parameter (associated with the target Gn/Gp SGSN) may be provided in the message.

Message 3: In the case of a dynamic PCRF being deployed, an update may be initiated over Gx. According to some of the example embodiments, the maximum allowed QoS associated with the target Gn/Gp SGSN may be sent from the GGSN or PGW to the PCRF over Gx. In the case of roaming, the parameter may be in addition provided over S9 from the V-PCRF to the H-PCRF.

Message 4: In the case a dynamic PCRF is deployed, the (H-)PCRF responds with a policy decision. According to some of the example embodiments, in case the PCRF supports the maximum allowed Gn/Gp SGSN QoS parameter, it should not decide on a QoS higher than the provided maximum allowed QoS for the default bearer or for any potential following dedicated bearers.

Message 5: In the case a dynamic PCC was not deployed in the network, message 3 and 4 do not apply. In this case it is the GGSN or PGW that makes a local policy decision (based e.g. on configuration). According to some of the example embodiments, for this case if the GGSN or PGW supports the maximum allowed QoS associated with the target Gn/Gp SGSN it should not decide on a QoS higher than the provided maximum allowed QoS for any the PDP contexts. The GGSN or PGW responds with Update PDP Context Response to the Gn/Gp SGSN. According to some of the example embodiments, in the case the GGSN or PGW supports the maximum allowed QoS associated with the target Gn/Gp SGSN and in case the Maximum allowed QoS was lower than the current QoS of the PDN connections or any of the related bearers, the GGSN or PGW may indicate that it accepts the Gn/Gp SGSN provided maximum allowed QoS in the Update PDP Context Response. The GGSN or PGW may indicate the selected QoS.

If the policy decision (made either locally by the GGSN or PGW, or received from the PCRF in the case dynamic PCC is deployed) was not in line with the maximum allowed QoS that was accepted for the existing bearers of the PDN connection, then the GGSN or PGW shall attempt to update the affected bearers with the applicable QoS directly after this procedure.

Message 6: The handover procedure continues according to standard procedures.

Message 7: According to some of the example embodiments, after the RAU Accept has been sent to the user equipment, in case the maximum allowed Gn/Gp SGSN QoS parameter is lower or equal than the current QoS of the PDN connections or any of the related PDP contexts, and the GGSN or PGW has indicated that it accepts the Gn/Gp SGSN provided maximum allowed QoS in the Update PDP Context Response, then the Gn/Gp SGSN may initiate a SGSN initiated Modify PDP Context procedure towards user equipment but without the signalling towards the GGSN or PGW. When the Gn/Gp-SGSN receives the Modify PDP Context Accept from the user equipment, there should be no signalling towards the GGSN or PGW. Also modifications from the Gn/Gp SGSN towards the RNC/BSC may be initiated for this reason and without signalling towards the GGSN or PGW.

Message 8: The handover procedure concludes according to standard procedures.

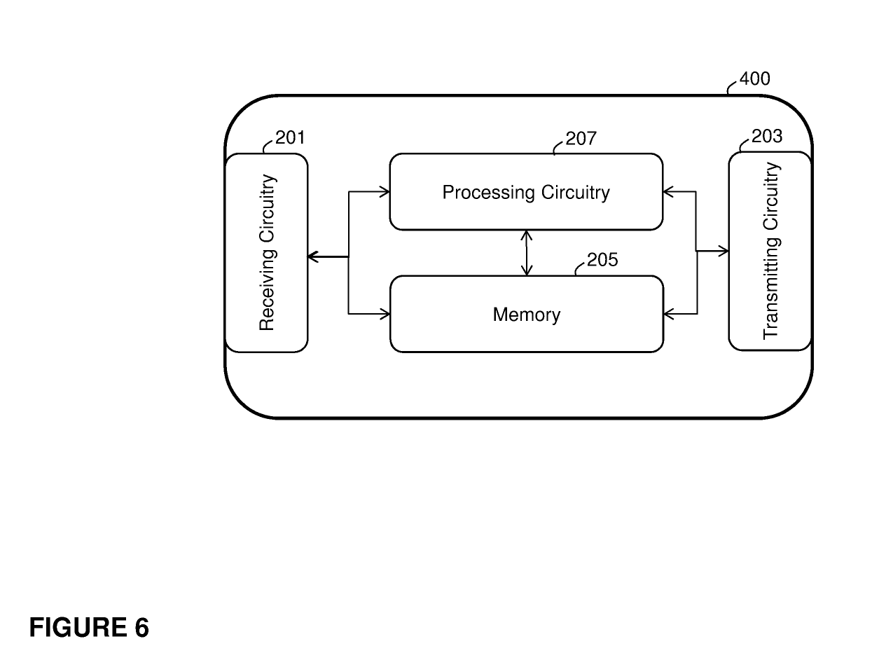

FIG. 6 illustrates an example core network node 400 according to some of the example embodiments. It should be appreciated that, according to some of the example embodiments, the core network node 400 may be a Gn/Gp SGSN 126, a GGSN 116, or a PGW 110. The core network node 400 may comprise any number of communication ports or circuitry, for example receiving circuitry 201 and transmitting circuitry 203. The transmitting and receiving circuitry may be configured to receive and transmit any form of communications data or instructions. It should be appreciated that the core network node 400 may alternatively comprise a single transceiver port or transceiving circuitry. It should further be appreciated that the communication or transceiver port or circuitry may be in the form of any input/output communications port or circuitry known in the art.

The core network node 400 may further comprise at least one memory unit 205. The memory unit 205 may be configured to store received, transmitted, and/or measured data of any kind and/or executable program instructions. The memory unit 205 may also be configured to store any number or type of QoS parameters or related information. The memory unit 205 be any suitable type of computer readable memory and may be of a volatile and/or non-volatile type.

The core network node 400 may also comprise processing circuitry 207. The processing circuitry may be configured to compare various QoS parameters or QoS related information. The processing circuitry 207 may also be configured to make recommendations or decisions for any form of communications requests.

It should be appreciated that the processing circuitry 207 may be any suitable type of computation unit, e.g. a microprocessor, digital signal processor (DSP), field programmable gate array (FPGA), application specific integrated circuit (ASIC), or any other type of circuitry which may be configured to carry out the example embodiments presented herein. It should also be appreciated that the processing circuitry 207 need not be comprised as a single unit. The processing circuitry 207 may be comprised as any number of units.

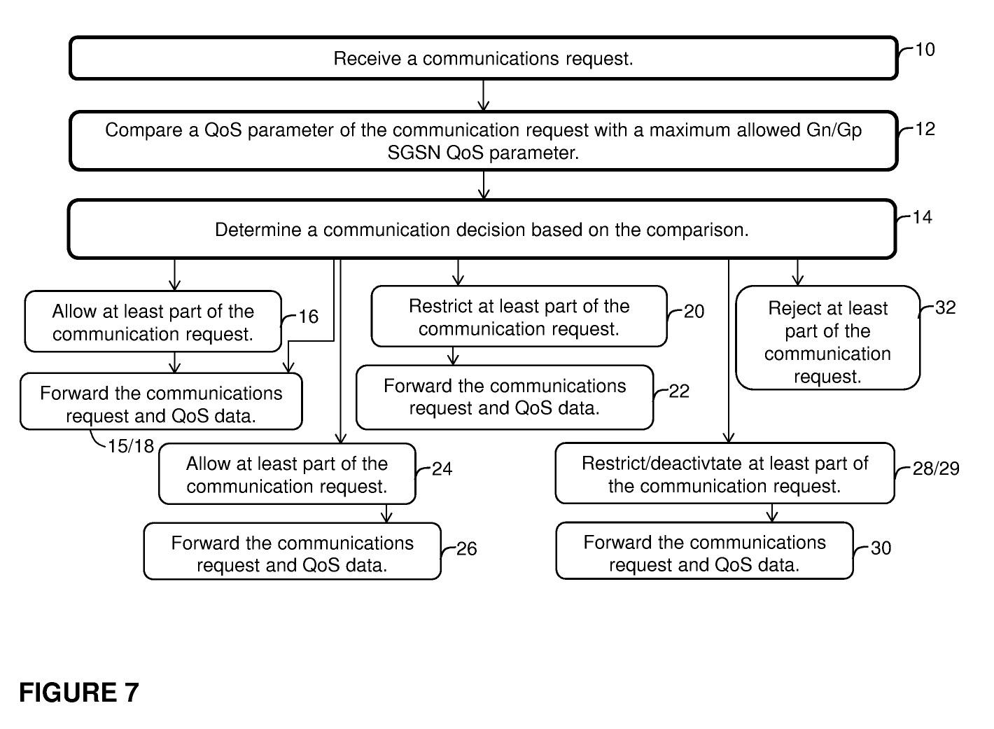

FIG. 7 is a flow diagram depicting example operations which may be taken by the core network node 400. The example operations provided below are associated with a received communications request. It should be appreciated that the received communications request may be associated with any number of PDP contexts or EPS bearers. Therefore, if a communications request is allowed, restricted, or rejected at least in part, this refers to at least one PDP context or EPS bearer associated with the communications request being allowed, restricted, or rejected.

It should also be appreciated that the example embodiments refer to a requesting node. If the communications request is a user equipment initiated request, the requesting node may be GGSN or a PGW, where an initial request may be motivated or provided by a user equipment and/or a base station. If the communications request is a network initiated request, the requesting node may be a GGSN, a Gn/Gp SGSN, a MME, or a S4-SGSN. It should be appreciated that the requesting node may be any node that initiates a procedure or sends the Gn/Gp a communications request as described herein.

Operation 10:

According to the example embodiments, the core network node 400 is configured to receive 10, from a requesting node, a communications request. The communications request is PDP context activation or a PDP context modification request. The receiving circuitry 201 is configured to receive, from the requesting node, the communications request.

It should be appreciated that according to some of the example embodiments, the communications request may further comprise an indication flag with two settings. One setting of the indication flag may be a support setting indicating the requesting node supports maximum allowed Gn/Gp SGSN QoS parameter handling. A second setting of the indication flag may be a non-support setting indicating the requesting node does not support maximum allowed Gn/Gp SGSN QoS parameter handling. It should be appreciated that the indication flag may be in the form of any flag or information element known in the art.

Operation 12:

According to the example embodiments, the core network node 400 is configured to compare 12 a QoS parameter with a maximum allowed Gn/Gp SGSN QoS parameter. The maximum allowed Gn/Gp SGSN QoS parameter indicates a maximum allowed QoS of a serving network. The QoS parameter is associated with the communications request. The processing circuitry 207 is configured to compare the QoS parameter with a maximum allowed Gn/Gp SGSN QoS parameter.

Operation 14:

According to the example embodiments, the core network node 400 is configured to determine 14 a communication decision, within the core network node 400, for the communications request based the comparing 14. The processing circuitry 207 is configured to determine the communication decision for the communications request based on the comparison.

Example Operation 15:

According to some of the example embodiments, the communications request may be a user equipment, mobile station, a RBS or an eNodeB initiated request and the QoS parameter associated within the communications request is a subscription QoS retrieved from a Home Location Register. Some non-limiting examples of such a communications request may be a Routing Area Update, Tracking Area Update, Packet Data Protocol Context Activation Request, a Secondary Packet Data Protocol Context Activation Request, an Inter SGSN Routing Area Update Request for A/Gb mode, a Combined SGSN Routing Area/Location Area Request for A/Gb mode, a Routing Area Update Request for lu mode, an intra SGSN Request Routing Area Update for A/Gb mode and lu mode, a Combined intra SGSN Routing Area/Location Area Request for A/Gb mode, Serving Radio Network Subsystem Relocation Request, Combined Hard Handover and Serving Radio Network Subsystem Request, Combined Cell/User-level Resource Allocation Update and Serving Radio Network Subsystem Relocation Request, an Enhanced Serving Radio Network Subsystem Relocation Request, or a Mobile Station initiated modification. The communications request examples provided above may be used in accordance with example operations 15-22 and example operation 32.

According to some of the example embodiments, wherein the core network node is a Gn/Gp SGSN node and the requesting node is a user equipment, the determining 14 may further comprise forwarding 15 the communications request, the QoS parameter, and the maximum allowed Gn/Gp SGSN QoS parameter in an uplink direction for establishing a procedure defined in the communications request. The transmitting circuitry 203 is configured to forward the communications request, the QoS parameter, and the maximum allowed Gn/Gp SGSN QoS parameter in an uplink direction for establishing the procedure defined in the communications request. It should be appreciated that in this example embodiment, an indication flag may not be in use or may not be received.

Example Operation 16:

According to some of the example embodiments, if the indication flag is set to a non-support setting, the network node is a Gn/Gp SGSN and the requesting node is a GGSN, PGW, or a PCRF. According to some of the example embodiments, if the indication flag is set to a supporting setting, the core network node is a GGSN, PGW, or a PCRF and the requesting node is a Gn/Gp SGSN. It should be appreciated that the request is initiated by, or caused by, a user equipment and/or base station.

The determining 14 may further comprise allowing 16, at least part of the communications request if the QoS parameter is less than or equal to the maximum allowed Gn/Gp SGSN QoS parameter. The processing circuitry 207 may be configured to allow at least part of the communications request if the QoS parameter is less than or equal to the maximum allowed Gn/Gp SGSN QoS parameter.

Example Operation 18:

According to some of the example embodiments, the determining 14 and allowing 16 may further comprise forwarding 18 the communications request, and the QoS parameter for establishing a procedure defined in the communications request. The transmitting circuitry 203 may be configured to forward the communications request, and the QoS parameter for establishing the procedure defined in the communications request.

Example Operation 20:

According to some of the example embodiments, if the indication flag is set to a non-support setting, the core network node may be a Gn/Gp SGSN node and the requesting node may be a GGSN, a PGW, or a PCRF. If the indication flag is set to a support setting the core network node may be a GGSN, a PGW, or a PCRF, and the requesting node is a Gn/Gp SGSN. The determining 14 may further comprise restricting 20 at least part of the communications request if the QoS parameter is greater than the maximum allowed Gn/Gp SGSN QoS parameter. The processing circuitry 207 may be configured to restrict at least part of the communications request if the QoS parameter is greater than the maximum allowed Gn/Gp SGSN QoS parameter.

Example Operation 22:

According to some of the example embodiments, the determining 14 and the restricting 20 may further comprise forwarding the communications request, and the QoS parameter, to the requesting node for renegotiating or authorizing an allowed QoS for a procedure defined in the communications request. The transmitting circuitry 203 may be configured to the communications request, and the QoS parameter, to the requesting node for renegotiating or authorizing an allowed QoS for a procedure defined in the communications request.

Example Operation 24:

The communications request may be a network initiated request and the QoS parameter associated with the communications request is a requested QoS comprised in the communications request. A few non-limited examples of such a communications request may be a network initiated Packet Data Protocol context activation, a network initiated Secondary Packet Data Protocol Context Activation Request, a SGSN initiated Packet Data Protocol Context Modification Request, Gateway General Packet Radio Service Support Node initiated Modification Request, or a Packet Data Network Gateway initiated Modification Request. The communications request examples provided above may be used in accordance with example operations 24-32.

According to some of the example embodiments, if the indication flag is set to a non-support setting, the network node is a Gn/Gp SGSN and the requesting node is a MME, S4-SGSN or another Gn/Gp SGSN. According to some of the example embodiments, if the indication flag is set to a supporting setting, the core network node is a MME, S4-SGSN or Gn/Gp SGSN and the requesting node is another Gn/Gp SGSN.

According to some of the example embodiments, the determining 14 may further comprise allowing 24 at least part of the communications request if the QoS parameter is less than or equal to the maximum allowed Gn/Gp SGSN QoS parameter. The processing circuitry 207 may be configured to allow at least part of the communications request if the QoS parameter is less than or equal to the maximum allowed Gn/Gp SGSN QoS parameter.

Example Operation 26:

According to some of the example embodiments, the determining 14 and the allowing 24 may further comprise forwarding 26 the communications request and the requested QoS parameter for establishing a procedure defined in the communications request. The transmitting circuitry 203 may be configured to forward the communications request and the requested QoS parameter for establishing the procedure defined in the communications request. It should be appreciated that once the requested QoS parameter is approved and forwarded by the Gn/Gp SGSN node 126, the requested QoS parameter thereafter becomes an authorized QoS parameter.

Example Operation 28:

According to some of the example embodiments, if the indication flag is set to a support setting, the core network node is a S4-SGSN and the requesting node is a S4-SGSN, another Gn/Gp SGSN, or a MME. If the indication flag is set to a non-support setting, the core network node is a S4-SGSN, Gn/Gp SGSN, or a MME and the requesting node is another Gn/Gp SGSN. The determining 14 may further comprise restricting 28 at least part of the communications request if the QoS parameter is greater than the maximum allowed Gn/Gp SGSN QoS parameter. The processing circuitry 207 is configured to restrict at least part of the communications request if the QoS parameter is greater than the maximum allowed Gn/Gp SGSN QoS parameter, wherein a procedure defined in the communications request is a handover procedure.

Example Operation 29:

According to some of the example embodiments, where the core network node is a S4-SGSN, Gn/Gp SGSN, or a MME, and the requesting node is another Gn/Gp SGSN. The determining 14 may further comprise deactivating 29 at least part of the communications request if the QoS parameter is greater than the maximum allowed Gn/Gp SGSN QoS parameter. It should be appreciated that in this embodiment the indication flag may not be in use or may not yet be received. The processing circuitry 207 may be configured to deactivate at least part of the communications request if the QoS parameter is greater than the maximum allowed Gn/Gp SGSN QoS parameter.

Example Operation 30:

According to some of the example embodiments, the determining 14 and the deactivating or restricting 28 may further comprise forwarding 30 the communications request, the QoS parameter, and the maximum allowed Gn/Gp SGSN QoS parameter in an uplink direction for authorization or re-authorization of an allowed QoS for a procedure defined in the communications request. The transmitting circuitry 203 may be configured to forward the communications request, the QoS parameter, and the maximum allowed Gn/Gp SGSN QoS parameter in an uplink direction for authorization or re-authorization of an allowed QoS for a procedure defined in the communications request.

Example Operation 32:

According to some of the example embodiments, the determining 14 may further comprise rejecting 32 at least part of the communications request if the QoS parameter is greater than the maximum allowed Gn/Gp SGSN QoS parameter. The processing circuitry 207 may be configured to reject at least part of the communications request if the QoS parameter is greater than the maximum allowed Gn/Gp SGSN QoS parameter.

It should be understood by the skilled in the art that “user equipment” is a non-limiting term which means any wireless device or node capable of receiving in DL and transmitting in UL (e.g. PDA, laptop, mobile, sensor, fixed relay, mobile relay or even a radio base station, e.g. femto base station). The example embodiments are not limited to LTE, but may apply with any RAN, single- or multi-RAT. Some other RAT examples are LTE-Advanced, UMTS, HSPA, GSM, cdma2000, HRPD, WiMAX, and WiFi.

It should also be appreciated that the QoS parameters discussed herein may comprise at least one of an EPS Bearer Level QoS and/or release 99 QoS parameters, or any other QoS parameters known in the art.

The foregoing description of embodiments of the example embodiments, have been presented for purposes of illustration and description. The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

The various example embodiments described herein is described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method in a core network node (400) for radio resource management, the core network node (400) being comprised in a radio network, the method comprising:
receiving (10), from a requesting node, a communications request, said communications request being a Packet Data Protocol, PDP, context activation or a PDP context modification request;
comparing (12) a Quality of Service, QoS, parameter with a maximum allowed Gn/Gp SGSN QoS parameter, said maximum allowed Gn/Gp SGSN QoS parameter indicating a maximum allowed QoS of a serving network, and said QoS parameter being associated with the communications request; and
determining (14) a communication decision, within the core network node, for the communications request based on the comparing (12).

2. The method of claim 1, wherein the communications request is a user equipment (130), Radio Base Station (128) or an eNodeB (129) initiated request, initiated request and the QoS parameter associated with the communications request is a subscription QoS retrieved from a Home Location Register, wherein the communications request is a Routing Area Update, Tracking Area Update, Packet Data Protocol Context Activation Request, a Secondary Packet Data Protocol Context Activation Request, an Inter SGSN Routing Area Update Request for A/Gb mode, a Combined SGSN Routing Area/Location Area Request for A/Gb mode, a Routing Area Update Request for lu mode, an intra SGSN Request Routing Area Update for A/Gb mode and lu mode, a Combined intra SGSN Routing Area/Location Area Request for A/Gb mode, Serving Radio Network Subsystem Relocation Request, Combined Hard Handover and Serving Radio Network Subsystem Request, Combined Cell/User-level Resource Allocation Update and Serving Radio Network Subsystem Relocation Request, an Enhanced Serving Radio Network Subsystem Relocation Request or a Mobile Station initiated modification.

3. The method of claim 2, wherein the network node is a Gn/Gp SGSN node and the requesting node is a user equipment, the determining (14) further comprising forwarding (15) the communications request, the QoS parameter, and the maximum allowed Gn/Gp SGSN QoS parameter in an uplink direction for establishing a procedure defined in the communications request.

4. The method of claim 2, wherein the communications request further comprises an indication flag indicating that the requesting node does not support maximum allowed Gn/Gp SGSN QoS parameter handling and the core network node is a Gn/Gp SGSN node and the requesting node is a GGSN, PGW, or a PCRF, the determining (14) further comprises:
allowing (16) at least part of the communications request if the QoS parameter is less than or equal to the maximum allowed Gn/Gp SGSN QoS parameter; and
forwarding (18) the communications request, the QoS parameter for establishing a procedure defined in the communications request.

5. The method of claim 2, wherein the communications request further comprises an indication flag indicating that the requesting node does support maximum allowed Gn/Gp SGSN QoS parameter handling and the core network node is a GGSN, PGW, or a PCRF and the requesting node is a Gn/Gp SGSN, the determining (14) further comprises allowing (16) at least part of the communications request if the QoS parameter is less than or equal to the maximum allowed Gn/Gp SGSN QoS parameter.

6. The method of claim 2, wherein the communications request further comprises an indication flag indicating that the requesting node does not support maximum allowed Gn/Gp SGSN QoS parameter handling and the core network node is a Gn/Gp SGSN node and the requesting node is a GGSN, PGW, or a PCRF, the determining (14) further comprises:
restricting (20) at least part of the communications request if the QoS parameter is greater than the maximum allowed Gn/Gp SGSN QoS parameter; and
forwarding (22) the communications request, the QoS parameter to the requesting node for re-negotiating or authorizing an allowed QoS for a procedure defined in the communications request.

7. The method of claim 2, wherein the communications request further comprises an indication flag indicating that the requesting node does support maximum allowed Gn/Gp SGSN QoS parameter handling and the core network node is a GGSN, PGW, or a PCRF and the requesting node is a Gn/Gp SGSN, the determining (14) further comprises restricting (20) at least part of the communications request if the QoS parameter is greater than the maximum allowed Gn/Gp SGSN QoS parameter.

8. The method of claim 1, wherein the communications request is a network initiated request and the QoS parameter associated with the communications request is a requested QoS comprised in the communications request, wherein the communications request, a network initiated Packet Data Protocol context activation, a network initiated Secondary Packet Data Protocol Context Activation Request, a SGSN initiated Packet Data Protocol Context Modification Request, Gateway General Packet Radio Service Support Node initiated Modification Request, or a Packet Data Network Gateway initiated Modification Request.

9. The method of claim 8, wherein the communications request further comprises an indication flag indicating that the requesting node does not support maximum allowed Gn/Gp SGSN QoS parameter handling and the core network node is a Gn/Gp SGSN node and the requesting node is a S4-SGSN, another Gn/Gp SGSN, of a Mobility Management Entity, MME, the determining (14) further comprises:
allowing (24) at least part of the communications request if the QoS parameter is less than or equal to the maximum allowed Gn/Gp SGSN QoS parameter; and
forwarding (26) the communications request, the requested QoS parameter, for establishing a procedure defined in the communications request.

10. The method of claim 8, wherein the communications request further comprises an indication flag indicating that the requesting node does support maximum allowed Gn/Gp SGSN QoS parameter handling and the core network node is a S4-SGSN, Gn/Gp SGSN, of a Mobility Management Entity, MME node and the requesting node is another Gn/Gp SGSN, the determining (14) further comprises allowing (24) at least part of the communications request if the QoS parameter is less than or equal to the maximum allowed Gn/Gp SGSN QoS parameter.

11. The method of claim 8, wherein the communications request further comprises an indication flag indicating that the requesting node does not support maximum allowed Gn/Gp SGSN QoS parameter handling and the core network node is a Gn/Gp SGSN node and the requesting node is a S4-SGSN, another Gn/Gp SGSN, of a Mobility Management Entity, MME, the determining (14) further comprises:
restricting (28) at least part of the communications request if the QoS parameter is greater than the maximum allowed Gn/Gp SGSN QoS parameter; and
forwarding (30) the communications request, the QoS parameter, and the maximum allowed Gn/Gp SGSN QoS parameter in an uplink direction for authorization or re-authorization an allowed QoS for a procedure defined in the communications request.

12. The method of claim 8, wherein the communications request further comprises an indication flag indicating that the requesting node does support maximum llowed Gn/Gp SGSN QoS parameter handling setting and the core network node is a S4-SGSN, Gn/Gp SGSN, of a Mobility Management Entity, MME node and the requesting node is another Gn/Gp SGSN, the determining (14) further comprises restricting (28) at least part of the communications request if the QoS parameter is greater than the maximum allowed Gn/Gp SGSN QoS parameter, wherein a procedure defined in the communications request is a handover procedure.

13. The method of claim 8, wherein the core network node is a S4-SGSN, Gn/Gp SGSN, or a MME node and the requesting node is a Gn/Gp SGSN, the determining (14) further comprises deactivating (29) at least part of the communications request if the QoS parameter is greater than the maximum allowed Gn/Gp SGSN QoS parameter.

14. The method of claim 1, wherein the determining (14) further comprises deactivating or rejecting (32) at least part of the communications request if the QoS parameter is greater than the maximum allowed Gn/Gp SGSN QoS parameter.

15. The method of any of claim 1, wherein the communications request is associated with at least one Packet Data Protocol context or at least one Evolved Packet System bearer.

16. A core network node (400) for radio resource management, the core network node (400) being comprised in a radio network, the core network node comprising:
receiving circuitry (201) configured to receive, from a requesting node, a communications request, said communications request being a Packet Data Protocol, PDP, context activation or a PDP context modification request;
processing circuitry (207) configured to process a Quality of Service, QoS, parameter with a maximum allowed Gn/Gp SGSN QoS parameter, said maximum allowed Gn/Gp SGSN QoS parameter indicating a maximum allowed QoS of a serving network, and said QoS parameter being associated with the communications request; and
the processing circuitry (207) further configured to determine a communication decision, within the Gn/Gp SGSN node, for the communications request based on the comparison.

17. The core network node of claim 16, wherein the communications request is a user equipment (130), Radio Base Station (128) or an eNodeB (129) initiated request, and the QoS parameter associated with the communications request is a subscription QoS retrieved from a Home Location Register, wherein the communications request is a Routing Area Update, Tracking Area Update, Packet Data Protocol Context Activation Request, a Secondary Packet Data Protocol Context Activation Request, an Inter SGSN Routing Area Update Request for A/Gb mode, a Combined SGSN Routing Area/Location Area Request for A/Gb mode, a Routing Area Update Request for lu mode, an intra SGSN Request Routing Area Update for A/Gb mode and lu mode, a Combined intra SGSN Routing Area/Location Area Request for A/Gb mode, Serving Radio Network Subsystem Relocation Request, Combined Hard Handover and Serving Radio Network Subsystem Request, Combined Cell/User-level Resource Allocation Update and Serving Radio Network Subsystem Relocation Request, an Enhanced Serving Radio Network Subsystem Relocation Request or a Mobile Station initiated modification.

18. The core network node of claim 17, wherein the network node is a Gn/Gp SGSN node and the requesting node is a user equipment, the core network node further comprising transmitting circuitry (203) configured forward to the communications request, the QoS parameter, and the maximum allowed Gn/Gp SGSN QoS parameter in an uplink direction for establishing a procedure defined in the communications request.

19. The core network node of claim 17, wherein the communications request further comprises an indication flag indicating the requesting node does not support maximum allowed Gn/Gp SGSN QoS parameter handling, and the core network node is a Gn/Gp SGSN node and the requesting node is a GGSN, PGW, or a PCRF, the processing circuitry (207) is further configured to allow at least part of the communications request if the QoS parameter is less than or equal to the maximum allowed Gn/Gp SGSN QoS parameter; the core network node further comprising transmitting circuitry (203) configured to forward the communications request, the QoS parameter for establishing a procedure defined in the communications request.

20. The core network node of claim 17, wherein the communications request further comprises an indication flag indicating the requesting node does support maximum allowed Gn/Gp SGSN QoS parameter handling, and the core network node is a GGSN, PGW, or a PCRF and the requesting node is a Gn/Gp SGSN, the processing circuitry (207) is further configured to allow at least part of the communications request if the QoS parameter is less than or equal to the maximum allowed Gn/Gp SGSN QoS parameter.

21. The core network node of claim 17, wherein the communications request further comprises an indication flag indicating the requesting node does not support maximum allowed Gn/Gp SGSN QoS parameter handling, and the core network node is a Gn/Gp SGSN node and the requesting node is a GGSN, PGW, or a PCRF, the processing circuitry (207) is further configured to restrict at least part of the communications request if the QoS parameter is greater than the maximum allowed Gn/Gp SGSN QoS parameter; and the core network node further comprising transmitting circuitry (203) configured to forward the communications request, the QoS parameter to the requesting node for re-negotiating or authorizing an allowed QoS for a procedure defined in the communications request.

22. The core network node of claim 17, wherein the communications request further comprises an indication flag indicating the requesting node does support maximum allowed Gn/Gp SGSN QoS parameter handling, and the core network node is a GGSN, PGW, or a PCRF and the requesting node is a Gn/Gp SGSN, the processing circuitry (207) is further configured to restrict at least part of the communications request if the QoS parameter is greater than the maximum allowed Gn/Gp SGSN QoS parameter.

23. The core network node of claim 16, wherein the communications request is a network initiated request and the QoS parameter associated with the communications request is a requested QoS comprised in the communications request, wherein the communications request is a network initiated Packet Data Protocol context activation, a network initiated Secondary Packet Data Protocol Context Activation Request, a SGSN initiated Packet Data Protocol Context Modification Request, Gateway General Packet Radio Service Support Node initiated Modification Request, or a Packet Data Network Gateway initiated Modification Request.

24. The core network node of claim 23, wherein the communications request further comprises an indication flag indicating the requesting node does not support maximum allowed Gn/Gp SGSN QoS parameter handling, and the core network node is a Gn/Gp SGSN node and the requesting node is a S4-SGSN, another Gn/Gp SGSN, of a Mobility Management Entity, MME, the processing circuitry (207) is further configured to allow at least part of the communications request if the QoS parameter is less than or equal to the maximum allowed Gn/Gp SGSN QoS parameter; and the core network node further comprising transmitting circuitry (203) configured to forward the communications request, the requested QoS parameter, for establishing a procedure defined in the communications request.

25. The core network node of claim 23, wherein the communications request further comprises an indication flag indicating the requesting node does support maximum allowed Gn/Gp SGSN QoS parameter handling, and the core network node is a S4-SGSN, Gn/Gp SGSN, of a Mobility Management Entity, MME node and the requesting node is another Gn/Gp SGSN, the processing circuitry (207) is further configured to allow at least part of the communications request if the QoS parameter is less than or equal to the maximum allowed Gn/Gp SGSN QoS parameter.

26. The core network node of claim 23, wherein the communications request further comprises an indication flag indicating the requesting node does not support maximum allowed Gn/Gp SGSN QoS parameter handling, and the core network node is a Gn/Gp SGSN node and the requesting node is a S4-SGSN, another Gn/Gp SGSN, of a Mobility Management Entity, MME, the processing circuitry (207) is further configured to restrict at least part of the communications request if the QoS parameter is greater than the maximum allowed Gn/Gp SGSN QoS parameter; and the core network node further comprising transmitting circuitry (203) configured to forward the communications request, the QoS parameter, and the maximum allowed Gn/Gp SGSN QoS parameter in an uplink direction for authorization or re-authorization an allowed QoS for a procedure defined in the communications request.

27. The core network node of claim 23, wherein the communications request further comprises an indication flag indicating the requesting node does support maximum allowed Gn/Gp SGSN QoS parameter handling, and the core network node is a S4-SGSN, Gn/Gp SGSN, of a Mobility Management Entity, MME node and the requesting node is another Gn/Gp SGSN, the processing circuitry (207) is further configured to restrict at least part of the communications request if the QoS parameter is greater than the maximum allowed Gn/Gp SGSN QoS parameter, and wherein a procedure defined in the communications request is a handover procedure.

28. The core network node of claim 23, wherein the core network node is a S4-SGSN, Gn/Gp SGSN, or a MME node and the requesting node is a Gn/Gp SGSN, the processing circuitry (207) is further configured to deactivate at least part of the communications request if the QoS parameter is greater than the maximum allowed Gn/Gp SGSN QoS parameter.

29. The core network node of claim 16, wherein the processing circuitry (207) is further configured to deactivate or reject at least part of the communications request if the QoS parameter is greater than the maximum allowed Gn/Gp SGSN QoS parameter.

30. The core network node of claim 16, wherein the communications request is associated with at least one Packet Data Protocol context or at least one Evolved Packet System bearer.
